(19) United States
(12) Patent Application Publication
(10) Pub. No.: US 2026/0084996 A1
(43) Pub. Date: Mar. 26, 2026

(54) METHOD FOR DETERMINING BATCH THICKNESS IN AN ALL-ELECTRIC GLASS TANK

(71) Applicant: Schott AG, Mainz (DE)

(72) Inventors: Moritz Hauf, Mainz (DE); Markus Stock, Mitterteich (DE); Jürgen Eckl, Mitterteich (DE); Ulrich Schadeck, Mitterteich (DE); Rainer Eichholz, Mitterteich (DE)

(73) Assignee: Schott AG, Mainz (DE)

(21) Appl. No.: 19/341,076

(22) Filed: Sep. 26, 2025

(30) Foreign Application Priority Data
Sep. 26, 2024 (DE) 10 2024 127 950.8

(51) Int. Cl. C03B 5/24; C03B 5/02; G01B 11/06; G01B 15/02; G01B 17/02

(52) U.S. Cl. CPC C03B 5/245; C03B 5/023; G01B 11/0608; G01B 15/02; G01B 17/02

(57) ABSTRACT

A method for capturing and evaluating data on a batch blanket on a glass melt in a cold-top melting tank for the melting of glass includes: providing at least one sensor for contactlessly capturing data on the batch blanket at least at an end of a boom of a charger at which batch is applied to the glass melt; repeatedly capturing and storing (a) data of the batch blanket during operation of the melting tank with at least the at least one sensor, data being captured from at least 10 different positions of the batch blanket, and (2) respectively assigning the data to a position of the end of the boom and/or the at least one sensor; and processing the captured data and compiling a topographic map of the batch blanket.

### CROSS REFERENCE TO RELATED APPLICATIONS

This application claims priority to German Patent Application No. 10 2024 127 950.8 filed on Sep. 26, 2024, which is incorporated in its entirety herein by reference.

### BACKGROUND OF THE INVENTION

### 1. Field of the Invention

The present invention relates to a method for capturing and evaluating data on the batch blanket and/or the glass melt in particular in an all-electric cold-top melting tank for the melting of glass, and to the use of the method in a method for producing glass.

### 2. Description of the Related Art

For the purpose of reducing CO₂ emissions in glass production, there is increasing use of all-electric melting tanks in the production of glass and glass-ceramic.

In all-electric melting tanks, typically, the entire free surface area of the glass melt is blanketed with batch. This continuous batch blanket insulates the glass melt thermally from the top furnace, and so the surface temperature of the glass melt is lowered from around 1400° C. to 1650° C. to around 200° C. to 400° C. One effect of this is to maximize the melting performance and significantly improve the energy efficiency of the melting tank. The significantly colder top furnace, moreover, reduces risks for devices present in the top furnace such as the charger and top furnace materials and/or lowers the requirements in terms of thermal robustness for the construction of the top furnace.

In the operation of all-electric melting tanks, therefore, measures are generally taken to ensure a continuous batch blanket over the entire melt bath surface. This is done by locally measuring the thickness of the batch blanket and adapting batch charging accordingly.

It is possible to perform pointwise (temporally and spatially) determination of batch thickness manually, by poking with a rod via the side charge opening. With electrical tank heating engaged, this measurement method carries risks both to the personnel and the process and requires the deployment of staff. Moreover, the batch thickness can only be measured at one point, locally, and only with relative imprecision.

Given the dependency of batch blanket temperature on batch blanket thickness, the thickness of the batch blanket can be determined from the measured temperature. WO 8002833 and U.S. Pat. No. 3,980,460 describe movable chargers for cold-top tanks wherein, respectively, an IR sensor and a heat sensor measure the temperature of the batch blanket. In the event of excessive batch blanket temperature being found locally, a larger amount of batch is applied to the batch blanket at that point.

There are, additionally, methods in the prior art for measuring the distance between batch blanket and charger and thereby determining the level of the glass in the melting tank, the latter being kept constant by regulating the charge quantity. For example, U.S. Pat. No. 4,194,077 and U.S. Pat. No. 4,302,623 describe movable chargers for a cold-top tank which for that purpose have an ultrasonic sensor mounted at their respective ends, for measuring the distance to the batch blanket.

More extensive acquisition of data on the batch blanket has not so far been regarded in the prior art as necessary for the operation of a melting tank. At the same time, in light of the increasing importance of electric melting tanks, there is a need to optimise the operation of such melting tanks.

What is needed in the art are techniques allowing the operation of an all-electric melting tank to be optimized and enabling reaction to the melting process and to fluctuations in said process, in particular through locally and temporally adapted charging rates and, optionally, locally and temporally adapted melting rates, and also to provide stable and energy-efficient methods for glass production.

### SUMMARY OF THE INVENTION

In some embodiments provided according to the invention, a method for capturing and evaluating data on a batch blanket on a glass melt in a cold-top melting tank for the melting of glass includes: providing at least one sensor for contactlessly capturing data on the batch blanket at least at an end of a boom of a charger at which batch is applied to the glass melt; repeatedly capturing and storing (a) data of the batch blanket during operation of the melting tank with at least the at least one sensor, data being captured from at least 10 different positions of the batch blanket, and (2) respectively assigning the data to a position of the end of the boom and/or the at least one sensor; and processing the captured data and compiling a topographic map of the batch blanket.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 schematically shows a cross-section through a cold-top melting tank for implementing the method of the invention;

FIG. 2 schematically shows a plan view of a boom of a charger for implementing the method of the invention;

FIG. 3 schematically shows the measurement of a batch blanket and a batch blanket topography compiled therefrom; and

FIG. 4 schematically shows a cross-section through a cold-top melting tank for implementing the method of the invention, with an additional microwave heater.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

The invention relates to a method for capturing and evaluating data on the batch blanket and/or the glass level in particular in an all-electric cold-top melting tank for the melting of glass, and for utilizing these data for an optimized melting process. The data determined and processed here are data relating to both the spatial and the temporal change in batch thickness, and a batch blanket topography can be compiled.

The invention relates more particularly to a method for capturing and evaluating data on the batch blanket and optionally on the glass melt and optionally on the glass level in optionally an all-electric cold-top melting tank for the melting of glass, comprising the following steps:
providing at least one sensor 160 for contactlessly capturing data on the batch blanket 150 at least at that end of the boom 120 of a charger at which batch is applied to the glass melt,
repeatedly capturing and storing (a) data of the batch blanket 150 during operation of the melting tank 100 with at least the sensor 160, wherein data are captured from at least 10 different positions, optionally at least 100 different positions, of the batch blanket, and (2) respectively assigning the data to the position of the end of the boom 120 and/or the sensor 160,
processing the captured data and compiling a topographic map, optionally a global topographic map and/or optionally an optimal topography of the batch blanket 150.

The invention further relates to the use of the determination method of the invention in a method for producing glass, for controlling batch charging.

The term “topography” refers here to a description or representation of the three-dimensional structure of the batch blanket surface (see FIG. 3). The term “global topography” refers to the batch blanket surface topography as it changes in the course of the melting process. The term “optimal topography” refers to a batch blanket topography which may be determined by the method of the invention and which enables, for a specific melting process, the most stable process and/or the best glass quality.

In the context of this invention, it has been recognized that the operation of all-electric cold-top tanks can be improved and stabilized through extensive capture and evaluation of data on batch blanket and glass level. Furthermore, through the extensive capture and evaluation of data on batch blanket and glass level, the operation of all-electric cold-top tanks can be monitored and, in particular, local melting rates can be ascertained, allowing conclusions to be drawn about the flow in the tank interior.

It has been found, for example, that the topography of a batch blanket allows conclusions to be drawn about flows within the underlying glass melt. Such flows, while they cannot be measured directly in the ongoing operation of the melting tank, nevertheless play an important part in the energy efficiency of the tank, the wear of tank components, and the quality of the glass.

For example, the flow of the hot glass may cause locally different melting rates, or formation of gas in the melting process may cause the formation of “volcanoes”—that is, flows of released gases out of the melt. Such effects are detrimental to the energy efficiency of the tank and influence glass flow, possibly leading in turn to rapid shorting paths and thus poor glass quality.

A knowledge of batch thickness topography allows influence to be exerted over such processes, by spatial and temporal adaptation of batch charging quantity to these processes.

Possibilities include, for example, the following:
A higher charging rate can be established in regions with a relatively high melting rate, and a lower charging rate in regions with a low melting rate.
Optional microwave heating allows an additional conversion of the batch on the glass melt to be implemented or established in a targeted way in regions with a low melting rate. In regions with a heightened or high meltdown rate, the optional microwave heating can be reduced or disengaged entirely.
A predefined thickness pattern (which is not equally thick everywhere) can be kept constant over time—for example, a hexagonal pattern of thin batch blanket sites can be established whose distance from one another is optimized for glass viscosity and evaporation rates and which allow the escape of released gas from the melt.
An optimal batch thickness topography, once found, can be kept constant over time.

In the context of the invention, it has been found that as well as the spatially defined thickness of the batch blanket, the temporal constancy of the defined local thickness of the batch blanket is critical for a stable process.

The method of the invention therefore provides for the contactless capture of data on the total batch blanket and/or on the glass level and/or on the glass melt, especially in an all-electric cold-top melting tank. The data ascertained are evaluated, and a topographic map and optionally a global topographic map and/or optimal topography of the batch blanket is compiled. The data and the topographic map are captured at regular temporal intervals during operation of the tank, and the temporal changes in topography are evaluated and a global topography compiled. Furthermore, a batch blanket topography that is optimal for the respective melting process is determined and used for regulating the local charge quantity.

A cold-top melting tank is a continuously operating melting tank for glass where, from the top furnace of the tank onwards, there is no heating of the batch in ongoing operation. This means that the batch is not heated by burners or other heat sources acting from above on the batch over the melt. Optionally, however, a microwave heater 190 can be used to provide local support for the meltdown of the batch on the melt and its corresponding conversion into a glass melt. The microwave power, however, is released not from “above”, i.e. at the boundary layer between batch and air/gas, but rather from “below”, i.e. at the boundary layer between batch and glass melt.

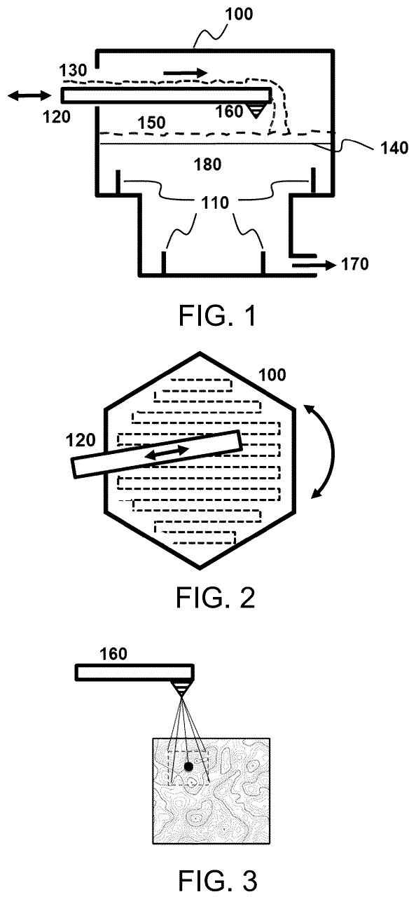

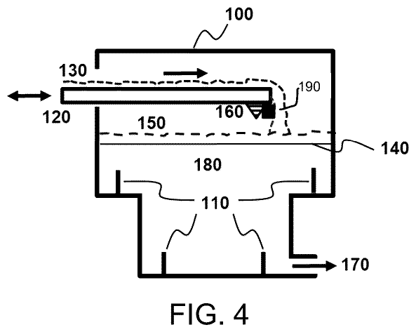

A schematic section through a cold-top melting tank 100 of this kind is shown in FIG. 1 and FIG. 4. The energy for melting the batch 150 and heating the glass melt 180 is introduced into the glass melt 180 in FIG. 1 exclusively by electrodes 110. The energy for melting the batch 150 and heating the glass melt 180 is introduced into the glass melt 180 in FIG. 4 by electrodes 110 and a microwave heater 190.

The batch 130 to be charged is applied to the surface of the glass melt 140 via the boom 120 of a charger. For efficient utilization of the heat introduced, the batch charged to the surface of the glass melt 140 forms a continuous batch pile 150. As shown in FIG. 2, for example, the boom 120 of the charger is able to traverse essentially the entire surface of the glass melt 140 and to apply batch 130 for charging to the surface of the glass melt 140 or to an existing batch blanket 150.

Mounted at least at the end of the boom 120 of a charger is at least one sensor 160 for the contactless measurement of the batch blanket and/or the glass level.

At least one sensor for detecting point data can be used—such a sensor for detecting point data may be selected from the group consisting of radar sensors, ultrasound sensors, laser triangulation sensors, laser (time-of-flight) sensors or combinations thereof. The point measurements obtained by such a sensor may be used directly for compiling the topographic map.

An additional possibility is to use, as well as or in place of one or more points sensors, at least one sensor for the distance capture of areas. A sensor of this kind for capturing areas may be selected from the group consisting, for example, of laser scanners, a 3D camera (time-of-flight, LIDAR), laser triangulation with line pattern, an IR camera, a photogrammetry sensor or combinations thereof. The area data obtained may be used directly or by assembly of overlapping subarea data for compiling the topographic map.

It is also possible to use combinations of at least one sensor for capturing point data and at least one sensor for capturing area data and to use the data obtained for compiling the topographic map.

According to some embodiments of the invention, one or more sensors may be housed in a water-cooled and/or air-cooled housing.

The sensor data may be captured during the batch charging procedure. Alternatively or additionally, a boom 120 may traverse the surface of the glass melt 180 even without charging of batch, just to record measurement data by a sensor 160 mounted, for example, on the end of the boom 120.

The measurement data obtained are processed together with the respective position of the boom 120 and optionally a topography of the batch blanket is compiled (see FIG. 3). Such a topography is determined at regular intervals and the change in the topography is used for determining an optimal batch blanket topography. In ongoing operation, the respective topography determined is compared with the specified optimal batch blanket topography and the batch charging amount that is optimal for each position is determined and applied. Additionally, deviations from the evolution of the batch blanket topography may be used to detect problems in the melting-tank process regime at an early stage.

According to some embodiments of the invention, at least one microwave heater may be provided. This at least one microwave heater is able to generate energy in the form of microwave radiation, with the microwave radiation generated covering at least a part of the transition between batch and rough melt. Rough melt is a technical term from glass technology and refers to the melt prior to fining. It is the first liquid-melt phase, in which all the raw materials have entered the liquid state but there are still bubbles present.

The microwave radiation couples into the upper region directly below the batch blanket, and hence into the meltdown reaction zone, where it raises the temperature and accelerates melting, in particular relative to or by comparison with an otherwise identical method where microwave radiation is not used. An advantage of this is that the batch blanket can be diminished locally and purposively, particularly in cold zones, where the batch blanket melts less quickly, or in zones at which more batch has been applied.

The at least one microwave heater is optionally mounted at least at that end of the boom 120 of a charger at which batch is applied to the glass melt. This allows the at least one microwave heater to be moved over the entire surface of the batch blanket, thereby enabling efficient and purposive irradiation of local regions.

According to some embodiments, the microwave heater generates microwave radiation with a frequency of higher than 500 MHz and lower than 6 GHz, more particularly lower than 3 GHz, optionally lower than or equal to 2.45 GHz or lower than or equal to 915 MHz. Microwave heaters and the melting of batch using microwave rays are familiar to the skilled person, from, for example, WO2021/175506 A1.

The invention further relates to the use of the determination method of the invention in a method for producing glass, for controlling batch charging.

The invention further relates to the use of the determination method of the invention in a method for producing glass, for controlling at least one microwave heater.

Accordingly, locally different melting rates and formation of “volcanoes”, caused by the flow of the hot glass and by formation of gas in the melting process, can be avoided and the energy efficiency of the tank can be improved.

Through control of the local thickness of the batch blanket, it is also possible to influence glass flow and to prevent shorting paths in the glass melt, so making it possible to improve glass quality.

Furthermore, the data captured and processed by the method of the invention can also be used, in combination with artificial intelligence, for the purpose, for example, of detecting anomalies in the melting process. Hence it is possible to detect unusual and thus potentially critical states in the glass melt and to provide early warning of process-critical situations.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

100 Cold-top melting tank
110 Electrodes
120 Batch charger
130 Batch on batch-charger conveyor belt
140 Glass melt surface
150 Batch blanket
160 Sensor
170 Outlet
180 Glass melt
190 Microwave heater

What is claimed is:

1. A method for capturing and evaluating data on a batch blanket on a glass melt in a cold-top melting tank for the melting of glass, comprising:
providing at least one sensor for contactlessly capturing data on the batch blanket at least at an end of a boom of a charger at which batch is applied to the glass melt;
repeatedly capturing and storing (a) data of the batch blanket during operation of the melting tank with at least the at least one sensor, wherein data are captured from at least 10 different positions of the batch blanket, and (2) respectively assigning the data to a position of the end of the boom and/or the at least one sensor; and
processing the captured data and compiling a topographic map of the batch blanket.

2. The method of claim 1, wherein the at least one sensor is used for capturing point data and the at least one sensor is selected from the group consisting of radar, ultrasound, laser triangulation, laser, a time-of-flight laser, light detection and ranging (LIDAR), and combinations thereof and/or the point data obtained are used directly for compiling the topographic map.

3. The method of claim 1, wherein the at least one sensor is used for capturing areas and the at least one sensor is selected from the group consisting of laser scanner, time-of flight 3D camera, light detection and ranging (LIDAR), laser triangulation with line pattern, infrared (IR) camera, photogrammetry, and combinations thereof and/or wherein area data obtained are used directly or by assembly of overlapping subarea data for compiling the topographic map.

4. The method of claim 1, wherein at least one sensor for capturing point data and one sensor for capturing area data are used and the data are used for compiling the topographic map.

5. The method of claim 1, wherein the data are captured during a batch charging procedure and/or wherein the data are captured without simultaneous batch charging.

6. The method of claim 1, further comprising capturing and processing data on a glass level and/or data on the glass melt.

7. The method of claim 1, wherein one or more sensors of the at least one sensor are housed in a water-cooled and/or air-cooled housing.

8. The method of claim 1, wherein at least one microwave heater is provided.

9. The method of claim 8, wherein the at least one microwave heater is mounted at least at that end of the boom of the charger at which batch is applied to the glass melt.

10. A use of the determination method of claim 1 for controlling batch charging to produce glass.

11. The use of claim 10, wherein locally smaller and/or larger batch thicknesses are established.

12. The use of claim 10, wherein an optimal batch blanket topography determined by the method is established.

13. A use of the determination method of claim 1 for controlling at least one microwave heater to produce glass.

14. The use of claim 13, wherein locally smaller and/or larger batch thicknesses are established.

15. The use of claim 13, wherein an optimal batch blanket topography determined by the method is established.
